(19) United States
(12) Patent Application Publication
(10) Pub. No.: US 2011/0256292 A1
(43) Pub. Date: Oct. 20, 2011

(54) Device and method for making food items

(76) Inventors: James C. Purgatorio, Woodridge, IL (US); Thomas Tapper, Schenectady, NY (US); Edward P. Bridgman, Bolingbrook, IL (US)

(21) Appl. No.: 12/799,045

(22) Filed: Apr. 16, 2010

(51) Int. Cl. A23P 1/00; A21D 13/00

(52) U.S. Cl. 426/549; 99/450.5

(57) ABSTRACT

Devices and methods for preparing and packaging food items, such as sandwiches, for example, are provided. The devices and methods of the invention are particularly suited for efficiently making and packaging any type of sandwich. In one embodiment, the device can be a food assembly workbench that defines at least one workstation having an elongated generally planar surface and a vertically extended consumables storage structure that extends above and offset from the worksurface and contains one or more garnish receptacles, one or more condiment dispenser receptacles and one or more holders for packaging materials for packaging the prepared sandwiches.

### TECHNICAL FIELD

This invention relates to the field of quick-service restaurant equipment and methods. More particularly, the invention relates to a device and method for efficiently making and packaging food items, such as, for example, sandwiches in a quick-service restaurant.

### BACKGROUND OF THE INVENTION

In quick-service restaurants, hundreds and even thousands of individual sandwiches may be served in one day at a single restaurant. Each sandwich has to be prepared and individually packaged. A need exists for equipment and methods for efficiently preparing and packaging sandwiches that is efficient and less tiresome for the people that make the sandwiches.

### SUMMARY OF THE INVENTION

In accordance with the invention, devices and methods for making and packaging food items are provided. In one embodiment, the device is particularly suited for efficiently making and packaging any type of sandwiches, such as, for example, hamburgers, chicken or fish filet sandwiches. The sandwiches may be bun-type sandwiches, wrap-type sandwiches (tacos, burritos or sandwich fillings and condiments wrapped in a soft flour tortilla, pita, other soft flatbread or other type of wrapping as desired, even lettuce, for example) and submarine sandwiches.

The device can be a food assembly workbench that defines at least one workstation for a human worker or crewperson. Preferably, the food assembly workbench is configured as an elongated table surface or workbench surface that preferably has a two-sided consumables storage area used in the making and packaging of restaurant sandwiches which is generally centrally located and extends longitudinally along and/or above, the table or workbench surface. Preferably, the workbench has a longitudinally extending food preparation area located on either side of the consumables storage area so that a single food assembly workbench has at least two workstations located on opposite longitudinal sides of the workbench. The consumables storage area contains condiments and packaging for the sandwich preparation and packaging and is also readily accessible from both of its two sides. The consumables are ergonomically located relative to each workstation to allow for efficient and less tiresome sandwich and other food preparation and packaging. The consumables area can be readily reconfigured if desired to accommodate the production of other food items or types of sandwiches. The consumables storage area can have a modular design and construction allowing modules and accessories to be added, deleted, replaced with different modules or accessories depending on the types of sandwiches or other food items that need to be prepared and packaged.

In accordance with another aspect of the invention, a food item assembly workbench for assembling and packaging food items in a quick-service restaurant is provided. The workbench is composed of a generally planar worksurface having sufficient width and length for the assembly and packaging of food items, such as sandwiches, for example. A vertically extending multitiered reconfigurable consumable storage structure extends above and is offset from the worksurface and contains one or more garnish receptacles, one or more condiment dispenser receptacles, and one or more holders for empty packaging materials for packaging the prepared sandwich.

In accordance with another aspect of the invention, the food item assembly workbench has a pair of spaced apart generally planar and elongated worksurfaces of sufficient width and length for the preparation and packaging of sandwiches. An elongated vertically extending multitiered reconfigurable consumable storage structure extends longitudinally between the pair of generally planar worksurfaces. Each worksurface defines a workstation at which a person may be located or stand to prepare and package the sandwich. The reconfigurable consumable storage structure is accessible from each of the workstations. The holders for packaging materials may include holders for sheet packaging material and clamshell sandwich cartons that are nested together while being stored. A cold well may be provided for containing receptacles for garnishes and other consumable items used in the preparation of sandwiches.

In accordance with another aspect of the invention, a method of preparing and packaging a food item, such as a sandwich, at a food item assembly station is provided. The method includes utilizing a food item assembly station that has a generally planar worksurface and a vertically extending multitiered reconfigurable consumable storage structure that extends above and offset from the worksurface. The consumable storage structure is configured for and contains one or more garnish receptacles, one or more condiment dispenser receptacles and one or more holders for packaging materials that can be used to package the prepared sandwich.

In accordance with another aspect of the invention, a sandwich assembly station for preparing and packaging sandwiches in a quick-service restaurant is provided. The sandwich assembly station includes a pair of spaced apart at least generally parallel and at least generally planar elongated worksurfaces each defining a separate working area and being of sufficient width and length for preparing and packaging sandwiches, a vertically extending multitiered reconfigurable consumables storage structure extending above and between the worksurfaces and is configured for containing and for permitting access from both working areas of one or more garnish receptacles, one or more condiment dispenser receptacles and one or more holders for packaging materials for packaging the prepared sandwich.

### BRIEF DESCRIPTION OF THE DRAWINGS

FIG. 1 is a perspective view of a food assembly workbench in accordance with the invention.

FIG. 2 is a front elevation view of a portion of the workbench of FIG. 1 without the workbench legs.

FIG. 3 is a perspective view of an alternate embodiment food assembly workbench in accordance with the invention.

FIG. 4 is a front elevation view of the food assembly workbench of FIG. 3 without the workbench legs.

FIG. 5 is a perspective view of a two-level wrap holder that can be incorporated into the food assembly workbench of the invention.

FIG. 6 is a perspective view of raised single level wrap holder that can be incorporated into the food assembly workbench of the invention.

FIGS. 7 and 8 are perspective views of two different bottle holders particularly adapted for holding squeeze bottles containing condiments that can be incorporated into the food assembly workbench of the invention.

FIGS. 9, 12 and 13 are perspective views of three different printer holding brackets that can be incorporated into the food assembly workbench of the invention.

FIG. 10 is a perspective view of a sauce gun holder particularly adapted for holding three sauce gun dispensers that can be incorporated into the food assembly workbench of the invention.

FIG. 11 is a perspective view of a portion of a rack and an adjustable container holder that can be incorporated into the food assembly workbench of the invention.

FIG. 14 is a perspective view of a condiment dispenser that can be incorporated into the food assembly workbench of the invention.

FIG. 15 is a perspective view of a condiment dispenser holder for holding two condiment dispensers of the type shown in FIG. 14 that can be incorporated into the food assembly workbench of the invention.

### DETAILED DESCRIPTION OF THE INVENTION

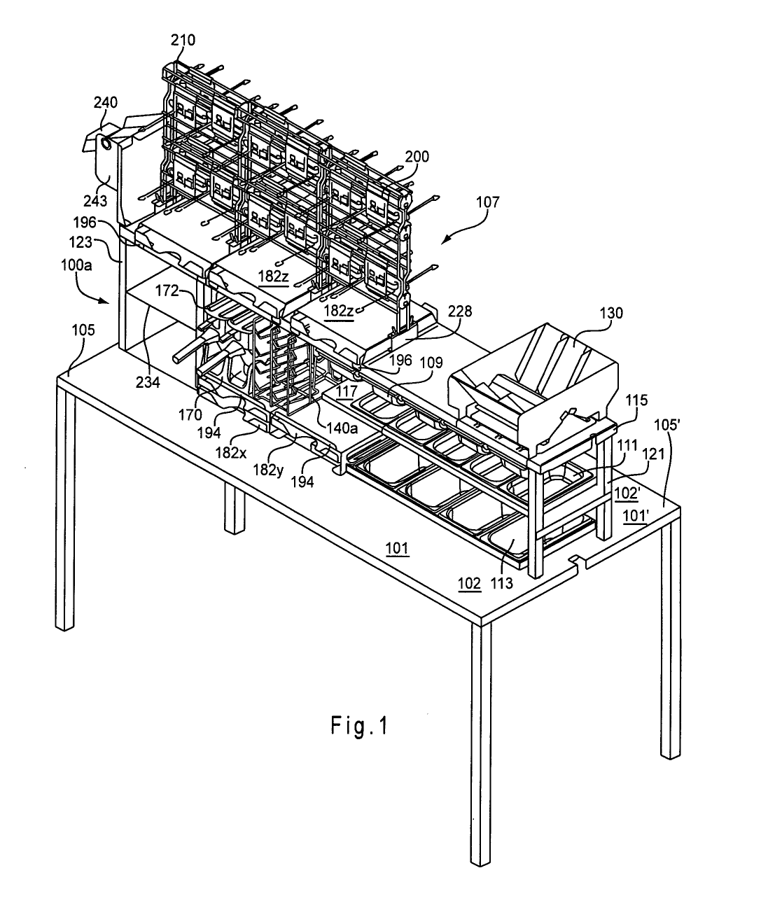

In one aspect of the invention, a workbench for assembling food items is provided. Two embodiments of the workbenches in accordance with the invention, workbenches 100a and 100b, are shown in FIGS. 1-2 and 3-4, respectively. For ease of description, an “a” accompanying a reference numeral will refer to workbench 100a, and a “b” accompanying a reference numeral will refer to workbench 100b. Workbenches 100a and 100b have at least one workstation 102. As illustrated, they have two workstations 102 and 102′ on opposed longitudinal sides 101 and 101′ of workbenches 100a and 100b. Workbenches 100a and 100b have worksurfaces 105 and 105′ and consumable storage structure 107 extending longitudinally along a central portion of workbenches 100a and 100b and stores items for use in assembling sandwiches from each of workstations 102 and 102′. Worksurfaces 105 and 105′ may be used for assembling food items like sandwiches, tacos, burritos, etc. and typically extend along both longitudinal perimeters of workbenches 100a and 100b.

Generally, suitably sized work surfaces 105 and 105′ will be at least 8″ wide and 24″ in length.

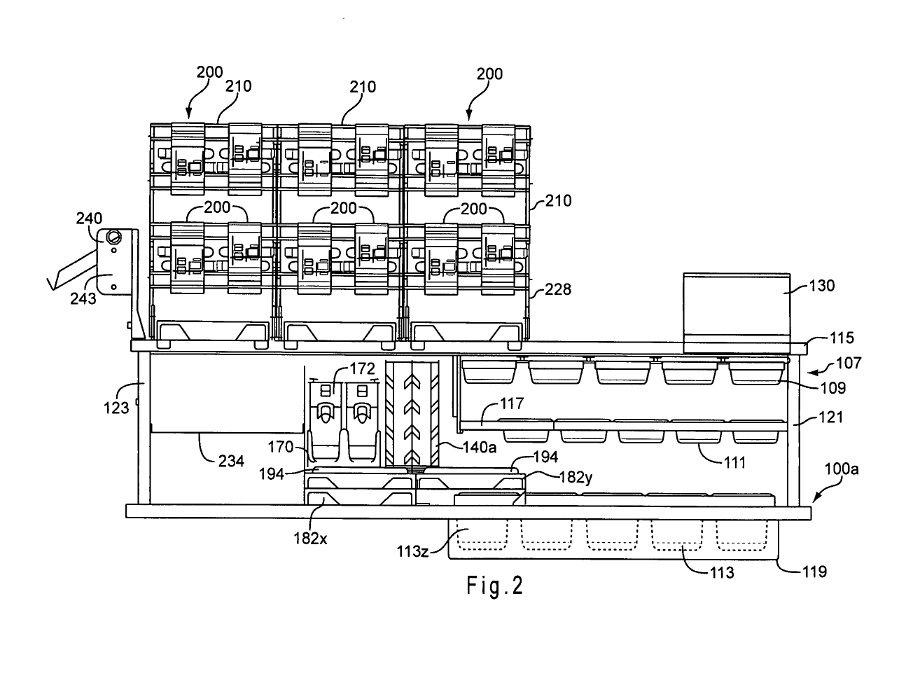

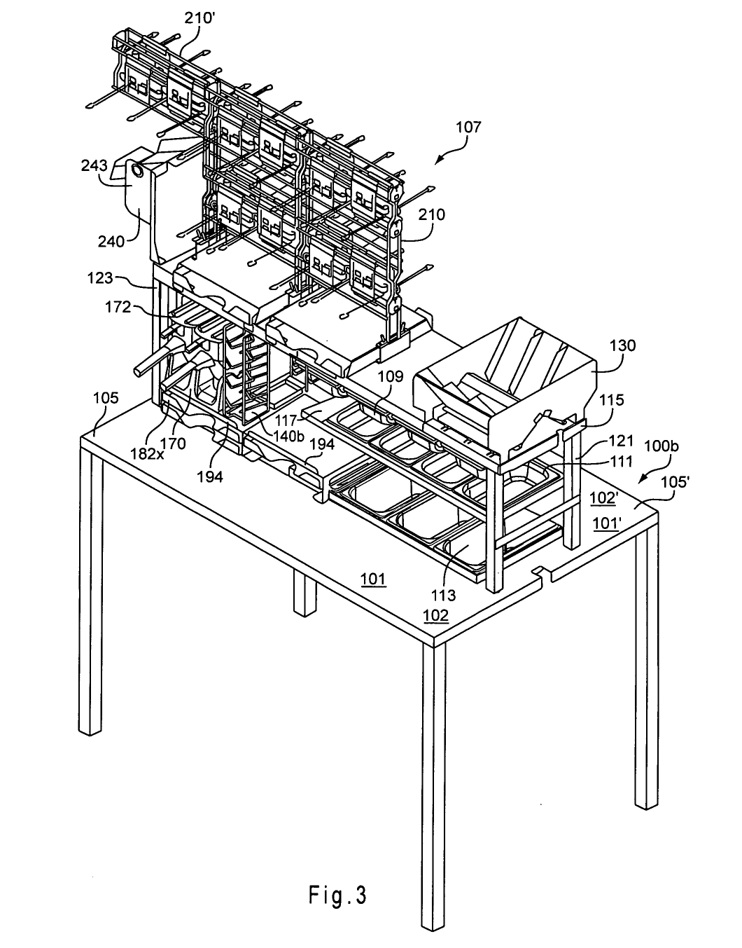

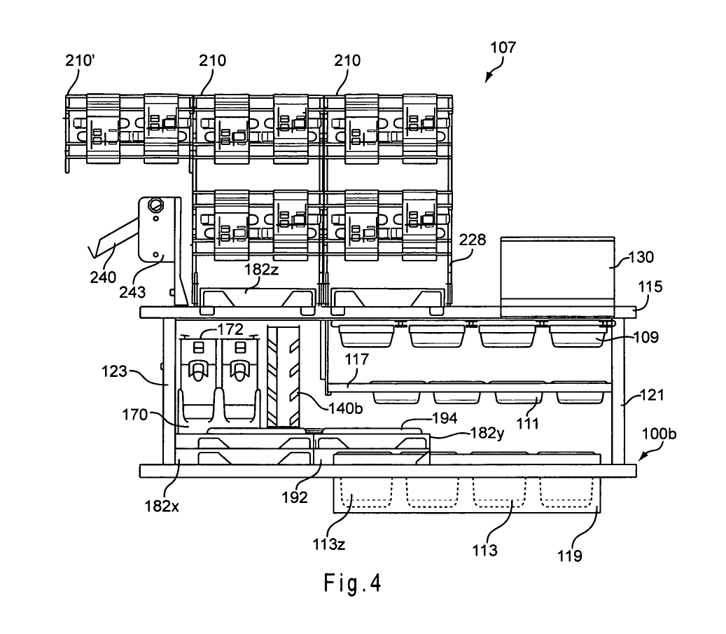

Consumable storage structure 107 is at least generally located above or on worksurface 105, extending longitudinally along a central longitudinal portion of workbench 100a and 100b. Some of consumable storage structure 107 may be located below worksurface 105, but is accessible from above worksurface 105 from each of workstations 102 and 102′. As illustrated, consumable storage structure 107 is a vertically extending multitiered reconfigurable consumables storage structure that extends above and is offset from the worksurfaces 105 and 105′. Consumable storage structure 107 can be configured or reconfigured to store desired consumables for sandwich or other food preparation and packaging and may be used to store, for example, any desired consumable, including but not limited to condiments, typically in bulk or in dispensers, sandwich wrappers, which may include a plurality of types and/or sizes of wrappers, different types of single-use sandwich containers such as the well-known types of clamshell cartons for hamburger sandwiches, garnishes, cheese, sauces and other items as desired. In one embodiment, the consumable items may be arranged ergonomically, with the items used most frequently located in consumable storage structure 107 closest to the right and/or left hands of a worker in position at either of workstations 102 or 102′. Items used less frequently are located as close as possible to the worker after the location of the most frequently used items. Such an arrangement enables a worker to work more quickly and efficiently, while being less tiresome. In addition, items may be used in a particular sequence and they may be located so as to require less worker hand travel given a particular sequence. In the illustrated embodiment, consumable storage structure 107 may include drawers 109, bins 111, bins 113, upper shelf 115 and lower shelf 117. Drawers 109 may be mounted to the underside of shelf 115. Bins 111 are suspended from shelf 117 located between shelf 115 and worksurface 105. Bins 113 extend below worksurface 105. Bins 113 may extend into a common well 119 (shown in FIGS. 2 and 4) that can be used to store ice or cooling or heating fluids for maintaining the contents of bins 113 cold or warm. In some embodiments not shown, there may be both a warm well 119 and a cold well 119. Bins 113 may be used to store garnishes like onions, tomatoes, and lettuce. Bins 113 preferably vary in number between 1 and 8, more preferably 4 and 5. Drawers 109 and bins 111 may be used to store any desired consumable or reusable materials. Shelf 115 may be supported by a pair of legs 121 and a pair of legs 123 located at the opposite end from where legs 121 are located or by any other suitable arrangement. For example, shelf 117 may be supported by legs 121 one end and may be suspended from shelf 115 on the other or another pair of legs (not shown).

Consumable storage structure 107 has various different receptacles for condiment dispensers permitting many different condiments to be within easy reach of a worker working at workbenches 100a and 100b. As illustrated, consumable storage structure 107 has a sauce gun receptacle 130, squeeze bottle holder 140 or 161, and a receptacle 170 for a bulk condiment dispenser 172. Sauce gun receptacle 130 may be sized and configured to hold 1, 2, 3 or 4 sauce guns for each workstation 102. As illustrated, sauce gun receptacle 130 is sized and configured to hold 3 sauce guns for each workstation 102. Sauce guns are typically used to hold viscous sauces like mayonnaise and tartar sauce. As shown in FIG. 10, sauce gun receptacle 130 has a compartment 132 for each sauce gun. Compartments 132 are separated by partitions 134. Compartments 132 have an inclined wall 138 against which the sauce guns can rest. Preferably, sauce gun receptacle 130 has two opposed lips 136 spaced apart so that they fit around shelf 115 and prevent receptacle 130 from being knocked off shelf 115.

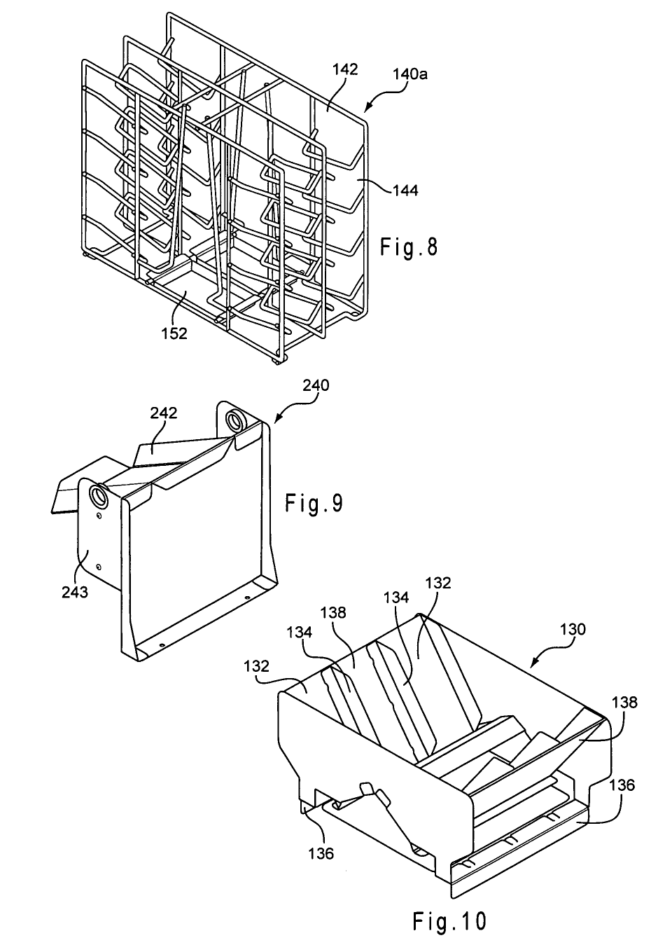

As illustrated, workbench 100a has squeeze bottle holder 140a and workbench 100b has squeeze bottle holder 140b. As best illustrated in FIG. 8, holder 140a has four columns 142, each having four compartments 144, each for holding a squeeze bottle. As illustrated, typically compartments 144 are formed by rigid rods or wire of suitable material such as metal or plastic, for example. Compartments 144 are inclined so that if a squeeze bottle is inserted nozzle first into compartment 144 then the contents of the squeeze bottle tend to collect towards the nozzle. Holder 140 may have one or more drip pans 152. Squeeze bottle holder 140b is substantially the same as squeeze bottle holder 140a except that it has a single column 142 of 4 compartments 144.

An alternative squeeze bottle holder 161, which may replace or supplement holders 140, is illustrated in FIG. 7. Holder 161 has four columns 163 of three compartments 165 and is capable of holding six squeeze bottles for each workstation 102. Squeeze bottle holders 140 and 161 may be secured in any suitable manner so that they cannot be easily dislodged or, for example, knocked over accidentally. They may be configured, for example, to be suspended from shelf 115 or 117 or they may be secured to the surface on which they rest by any suitable structure and can be supported, along with bulk condiment holder 170, by wrap holders 182x as shown in FIGS. 1-4. The number of columns 142 or 163 per workstation 102 can be as desired and typically can be 1, 2 or 3 for example. The number of compartments 144 or 165 per column can be as described and typically is 2, 3, 4 or 5, for example.

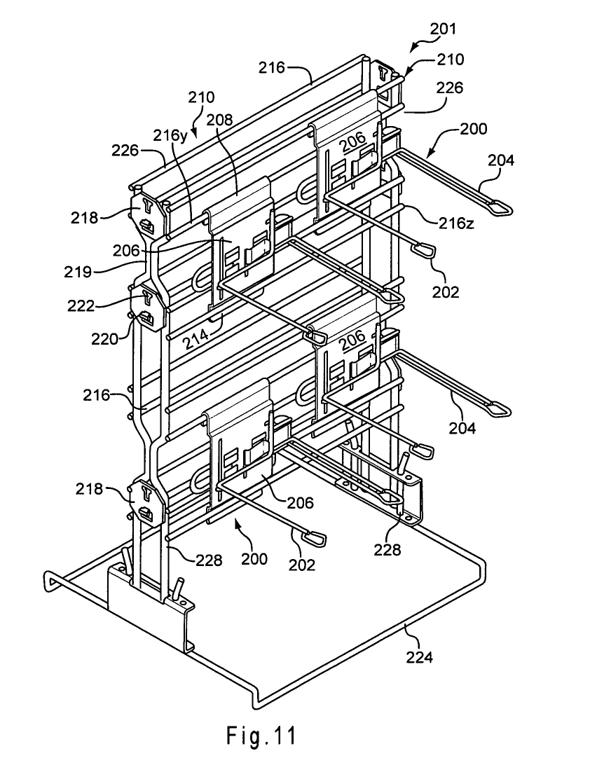

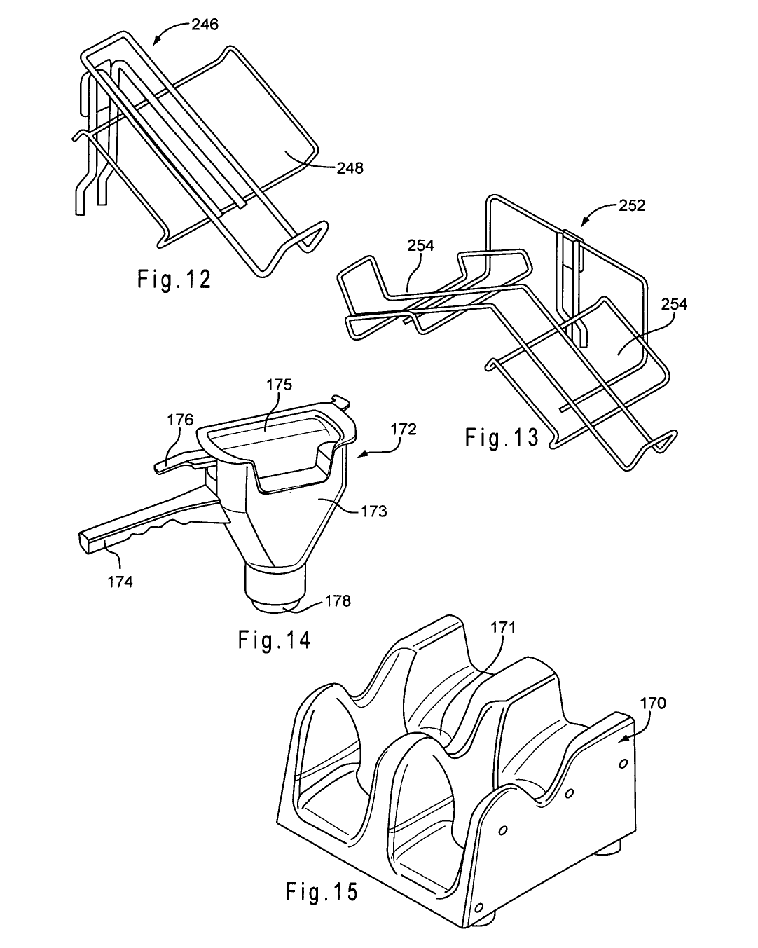

A fourth type of dispenser holder for bulk condiment dispenser 172 of FIG. 14 is holder 170 shown in FIG. 15. Bulk condiment dispenser 172 is typically used for ketchup or mustard and has a relatively large condiment capacity. Bulk condiment dispenser 172 includes a bulk storage hopper 173 for containing the condiment in bulk, a hopper lid 175, an elongated handle 174, a trigger 176, and a bottom-discharging nozzle 178. Dispenser holder 170 as shown in FIG. 15 is configured to store two condiment dispensers 172 of the type shown in FIG. 14. Thus, dispenser holder 170 has a complementary shape including a bottom well 171 so that the bottom of condiment dispenser 172 nests therein.

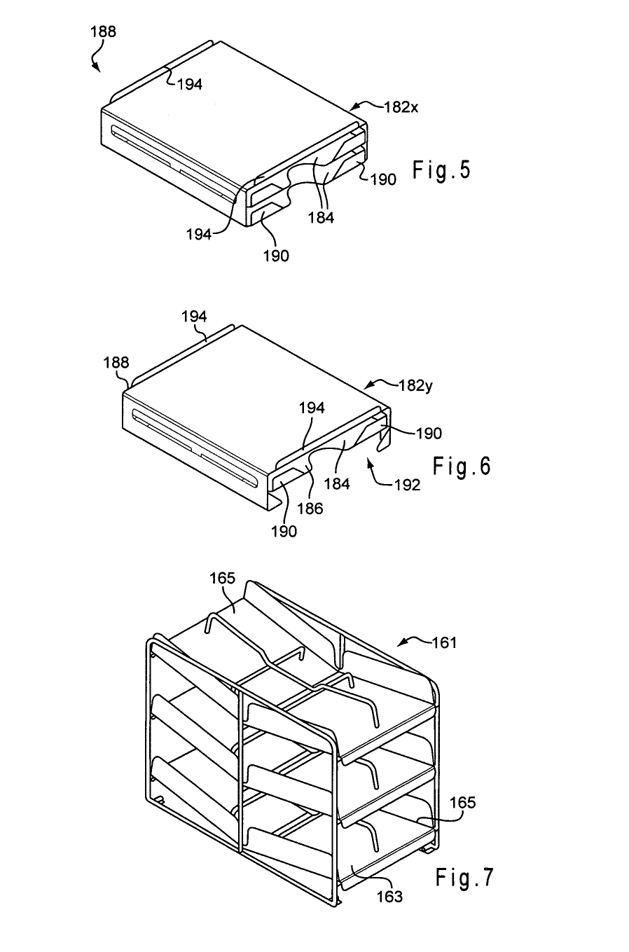

Each workstation 102 preferably has a variety of container storage devices for making containers of various types and sizes readily accessible to a worker at the workstation 102. The principal containers are for wraps or sheets and boxes or cartons, particularly clamshell boxes or cartons. A first type of container storage device is wrap holder 182. Wrap holder 182 may have one, two, three or more compartments 184, typically in one or two columns. Compartments 184 typically have opposed openings 186, 188 so that wraps are accessible from opposed workstations 102 and 102′. Compartments 184 may have wrap retainer tabs 190 for retaining wraps within the wrapholder while still allowing easy removal of wraps. Wrapholders 182x and 182y are best illustrated in perspective in FIGS. 5 and 6, respectively, and in a front elevation view in FIGS. 2 and 4. Wrap holder 182y has an access slot 192 permitting access to bin 113z. Wrapholders 182 have securement tabs 194 and/or 196. Securement tabs 194 removably and loosely secure items placed onto wrapholders 182x and y. Securement tabs 196 removably and loosely secure wrapholders 182z to shelf 115 on which they rest. Wrap holder 182 or similar wrap holder compartments may be located as desired, including below worksurfaces 105 and 105′ (not shown) and may be secured to the bottom surface of worksurfaces 105 and 105′ (not shown).

Another type of container storage device is adjustable container storage device 200, a plurality of which can be seen in FIG. 11 as part of container storage assembly 201. Preferred adjustable container storage devices 200 are disclosed in an application filed concurrently with this application and having attorney docket no. 25570-50897 and which is expressly incorporated by reference in its entirety. Device 200 has opposed prongs 202 and 204 that provide a clamping force sufficient to hold boxes between prongs. The distance between prongs 202 and 204 may be adjusted to accommodate containers of different widths. Prong 202 may be fixed while prong 204 may be slidingly mounted to a back plate 206. Prongs 202 and 204 typically hold a clamshell box at the hinge of the box. Back plate 206 is mounted to a wire rack 210 of container storage assembly 201, having a plurality of substantially horizontal wires 216. The mounting may be done in any manner known in the art. As shown in FIG. 11, back plate 206 has a top lip portion 208 that curves and hangs over a wire 216y of wire rack 210 and a foot portion 214 that hooks behind wire 216z. In an embodiment not shown, devices 200 are not adjustable and a plurality of devices 200 are provided having different spacings between prongs 202 and 204 to match containers of different widths.

Racks 210 may have mounting plates 218 on sides 219. Mounting plates 218 have a male coupling member 220 and a female coupling member 222. The location and shape of male coupling member 220 and female coupling member 222 are such that a first mounting plate 218 may be coupled to a second mounting plate 218 that is rotated 180 degrees relative to the first mounting plate. Preferably such mounting plates are used to couple wire rack 210 to wire rack 210′ as shown in FIGS. 3 and 4. Wire rack 210 has a foot portion 224 that hooks over shelf 115, while rack 210′ does not. Racks 210 may have two opposed faces 226 permitting storage device 200 to be mounted on both faces 226. As shown in FIGS. 1-4, leg portions 228 are sufficiently spaced so that wrapholders 182z can fit between them. It is to be understood that container storage assembly 201 may also include a plurality of container storage devices 200 mounted to wires 216 that face in the opposite direction from the devices 200 shown in FIG. 11 so that containers can be accessible from each of workstations 102 and 102′ for example.

A third type of container storage device is shelves 234 for miscellaneous storage.

Workbench 100 may also have a printer bracket 240, 246 or 252. Printer bracket 240 mounts to the end of shelf 115 as shown in FIGS. 1-4, while printer brackets 246 and 252 can mount to side 219 of rack 210. Brackets 240, 246 and 252 have cradle areas 242, 248, and 254, respectively, for holding a printer. Bracket 252 has two cradle areas 254. The printer may be a label printer for printing labels for special orders. A keypad or bump bar may be mounted to both sides 243 of printer bracket 240.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

1. A food item preparing and packaging workbench for preparing and packaging sandwiches at a quick-service restaurant, the workbench comprising:
a generally planar worksurface of sufficient width and length for the preparation and packaging of sandwiches;
a vertically extending multitiered reconfigurable consumable storage structure extending above and offset from the worksurface and containing one or more garnish receptacles, one or more condiment dispenser receptacles, and one or more holders for packaging materials for packaging the prepared sandwich.

2. The food item preparing and packaging workbench of claim 1 further comprising a cold well containing the one or more garnish receptacles.

3. The food item preparing and packaging workbench of claim 1 wherein the one or more condiment dispenser receptacles comprises a receptacle for holding bottles of condiments on their side.

4. The food item preparing and packaging workbench of claim 1 wherein the one or more condiment dispenser receptacles comprises a drawer.

5. The food item preparing and packaging workbench of claim 1 wherein the one or more condiment dispenser receptacles comprises a shelf-mounted open top container.

6. The food item preparing and packaging workbench of claim 1 further comprising a condiment dispenser in one of the condiment dispenser receptacles, the condiment dispenser for dispensing condiment by operation of a pump.

7. The food item preparing and packaging workbench of claim 6 wherein the condiment dispenser is operable to automatically dispense a fixed amount of condiment.

8. The food item preparing and packaging workbench of claim 1 further comprising a condiment dispenser in one of the condiment dispenser receptacles, wherein the condiment dispenser is a squeeze bottle.

9. The food item preparing and packaging workbench of claim 1 further comprising a condiment dispenser in one of the condiment dispenser receptacles, wherein the condiment dispenser is a sauce gun.

10. The food item preparing and packaging workbench of claim 1 wherein the one or more holders for packaging materials includes a holder for sandwich wrappers.

11. The food item preparing and packaging workbench of claim 1 wherein the one or more holders for packaging materials includes one or more holders for clamshell containers.

12. The food item preparing and packaging workbench of claim 10 wherein the holders for clamshell containers comprise two generally parallel spaced apart prongs.

13. The food item preparing and packaging workbench of claim 11 further comprising a rack to which is mounted the holders for clamshell containers, the prongs being substantially horizontal.

14. The food item preparing and packaging workbench of claim 1 further comprising a first workstation on a first side of the workbench and a second workstation on a second side of the workbench opposed to the first side, wherein the garnish receptacles, the condiment dispenser receptacles, and the holders for packaging materials are located between the first and second workstations.

15. A method of preparing and packaging a sandwich at a food item preparing and packaging workbench, the workbench comprising a generally planar worksurface and a vertically extending multitiered reconfigurable consumable storage structure extending above and offset from the worksurface and containing one or more garnish receptacles, one or more condiment dispenser receptacles, and one or more holders for packaging materials for packaging the assembled sandwich, the method comprising:
obtaining a sandwich filling and a sandwich bread component;
obtaining an empty container from one of the holders;
obtaining a garnish from one of the garnish receptacles from the consumable storage structure;
placing the obtained garnish onto the sandwich filling;
obtaining a condiment dispenser from one of the condiment dispenser receptacles of the consumable storage structure;
dispensing a condiment from the condiment dispenser over the sandwich filling;
completing the sandwich and placing the sandwich into the container; and thereafter
closing the container having the sandwich contained therein.

16. The method of claim 15 wherein the sandwich filling is selected from the group consisting of a meat, vegetable, fish, chicken and combinations thereof.

17. A sandwich assembly station for preparing and packaging sandwiches at a quick-service restaurant, comprising:
a pair of spaced apart generally parallel and planar elongated worksurfaces each defining a separate working area and being of sufficient width and length for preparing and packaging sandwiches;
a vertically extending multitiered reconfigurable consumable storage structure extending above and between the worksurfaces and configured for containing and for permitting access from both working areas of one or more garnish receptacles, one or more condiment dispenser receptacles, and one or more holders for packaging materials for packaging the prepared sandwich.

18. The food item assembly station of claim 17 wherein the one or more condiment dispenser receptacles includes a receptacle for holding bottles of condiments on their side.
